(19) United States
(12) Patent Application Publication
(10) Pub. No.: US 2015/0227709 A1
(43) Pub. Date: Aug. 13, 2015

(54) NETWORK-BASED HEALTHCARE MONITORING SYSTEM

(71) Applicant: MEDISEN LIMITED, Hong Kong (HK)

(72) Inventors: Hiu Fung Lam, Hong Kong (HK); Chi Yin Wong, Hong Kong (HK)

(73) Assignee: MEDISEN LIMITED

(21) Appl. No.: 14/616,765

(22) Filed: Feb. 9, 2015

Related U.S. Application Data
(60) Provisional application No. 61/939,275, filed on Feb. 13, 2014.

(30) Foreign Application Priority Data
Feb. 14, 2014 (HK) 14101459.6

(51) Int. Cl. G06F 19/00

(52) U.S. Cl. CPC G06F 19/3418; H04W 84/042

(57) ABSTRACT

This application discloses a network-based healthcare monitoring system, including a system server, a first user apparatus, and a second user apparatus, the first user apparatus includes a first computing device and a sports or healthcare device; the sports or healthcare device is used for measuring physiological data of a first user and sending the physiological data to the first computing device in a wireless communication manner; the first computing device is used for sending measured data to the system server; the second user apparatus includes a second computing device; and the system server is used for sending the physiological data to the second computing device. According to the system, not only first users can monitor their own states, but also second users can monitor the states of the first users, so that the states of the first users can be more effectively managed and controlled.

### CROSS-REFERENCE TO RELATED APPLICATIONS

This application claims the benefits of U.S. Provisional Patent Application No. 61/939,275 filed Feb. 13, 2014 and Hong Kong Short-term Patent Application No. 14101459.6 filed Feb. 14, 2014, the entire contents of which are hereby incorporated by reference.

### BACKGROUND

1. Technical Field

This application relates to a network-based healthcare monitoring system.

2. Related Art

At present, for some specific users such as the elderly or patients, there is no effective monitoring means for monitoring their health conditions. Children, doctors, and caregivers and the like of the elderly can often learn of the health conditions of the elderly only when they perform measurement on the elderly face to face, but they often cannot know the health conditions of the elderly in time when they are not by the side of the elderly. Therefore, a solution of assisting the specific users, such as the children of the elderly, in knowing well the health conditions of the elderly anytime and anywhere is urgently needed. In addition, by using this system, a first user and a second user can communicate with and care for each other better.

### SUMMARY

The present application is directed to a network-based healthcare monitoring system, including:

a system server;

a first user apparatus comprising a first computing device configured to communicate with a sports or healthcare device; the first computing device receiving physiological data of a first user measured and sent by the sports or healthcare device in a wireless communication manner and sending the physiological data to the system server; and

a second user apparatus comprising a second computing device; wherein

the system server may include a data storage device, and a central processing device configured to execute a specific instruction; the system server supports a wireless or wired access manner and sends the physiological data to the second computing device.

In an embodiment, the data storage device may include a blade storage array storing system-related data in the form of a database; and the central processing device executes the specific instruction so as to execute various system-related operations.

In an embodiment, the wireless or wired access manner may include: a WIFI/2G/3G/4G mobile network access manner, or a satellite communication or wireless broadcast communication access manner; and the wireless communication manner may include a BT/BLE/RF manner.

In an embodiment, the first computing device and the second computing device may include: a personal computer (PC), or a smart device;

the PC may include a desktop computer or a notebook computer running a windows operating system or an OS X operating system; and

the smart device may include a smartphone and a tablet computer running an IOS system or an Android system.

In an embodiment, the system server may include: a healthcare data analysis module configured to analyze the physiological data and provide a corresponding assessment or corresponding advice.

In an embodiment, the system server may include: an alert and reminding module configured to set an alert threshold and give out an alert when finding that the physiological data is out of the alert threshold; and

to set a schedule timetable reminder and give out a reminder when a scheduled time is up; wherein

the alert and the reminder use different alarm sounds or light according to different alert and reminder types or levels.

In an embodiment, the system server may include: a family communication module configured to implement chatting between system members.

In an embodiment, the system server may include: a history record module configured to record historical measurement data of the first user.

In an embodiment, the system server may include: user friendly design on which the first computing device and the second computing device are based.

In an embodiment, the user friendly design may include: an icon display and a voice-operated control.

In another aspect, the present application is directed to a network-based healthcare monitoring system, including:

a system server;

a first user apparatus including a first computing device and a sports or healthcare device; the sports or healthcare device measuring physiological data of a first user and sending the physiological data to the first computing device in a wireless communication manner; and the first computing device sending the physiological data to the system server;

a second user apparatus including a second computing device; wherein

the system server may include a data storage device, and a central processing device configured to execute a specific instruction; the system server supports a wireless or wired access manner and sends the physiological data to the second computing device.

In an embodiment, the first computing device and the second computing device may include: a personal computer (PC), or a smart device;

the PC may include a desktop computer or a notebook computer running a windows operating system or an OS X operating system;

the smart device may include a smartphone and a tablet computer running an IOS system or an Android system; and

the sports or healthcare device may include a sports wristwatch or a foot massage device.

In the third aspect, the present application is directed to a network-based healthcare monitoring method, including:

providing a system server;

sending physiological data of a first user, by a first user apparatus, to the system server; and

sending the physiological data, by the system server, to a second computing device; wherein

the system server may include a data storage device, and a central processing device configured to execute a specific instruction; the system server supports a wireless or wired access manner.

In an embodiment, the data storage device may include a blade storage array storing system-related data in the form of a database; and the central processing device executes the specific instruction so as to execute various system-related operations.

In an embodiment, the wireless or wired access manner may include: a WIFI/2G/3G/4G mobile network access manner, or a satellite communication or wireless broadcast communication access manner; and the wireless communication manner may include a BT/BLE/RF manner.

In an embodiment, the first computing device and the second computing device may include: a personal computer (PC), or a smart device;

the PC may include a desktop computer or a notebook computer running a windows operating system or an OS X operating system; and

the smart device may include a smartphone and a tablet computer running an IOS system or an Android system.

In an embodiment, the healthcare monitoring method may further include: analyzing the physiological data and providing a corresponding assessment or corresponding advice.

In an embodiment, the healthcare monitoring method may further include: setting an alert threshold and giving out an alert when finding that the physiological data is out of the alert threshold; and

setting a schedule timetable reminder and giving out a reminder when a scheduled time is up; wherein

the alert and the reminder use different alarm sounds or light according to different alert and reminder types or levels.

In an embodiment, the healthcare monitoring method may further include: recording historical measurement data of the first user.

In an embodiment, the system server may include: user friendly design on which the first computing device and the second computing device are based.

### BRIEF DESCRIPTION OF THE DRAWINGS

This application is further described hereinafter with reference to accompanying drawings and an embodiment. In the accompanying drawings:

FIG. 1 is a structural diagram of a system according to an embodiment of this application; and

FIG. 2 is a schematic diagram of main content of the system according to the embodiment of this application.

### DETAILED DESCRIPTION

For clearer understanding of technical features, objectives, and effects of this application, specific implementation manners of this application are described in detail with reference to accompanying drawings.

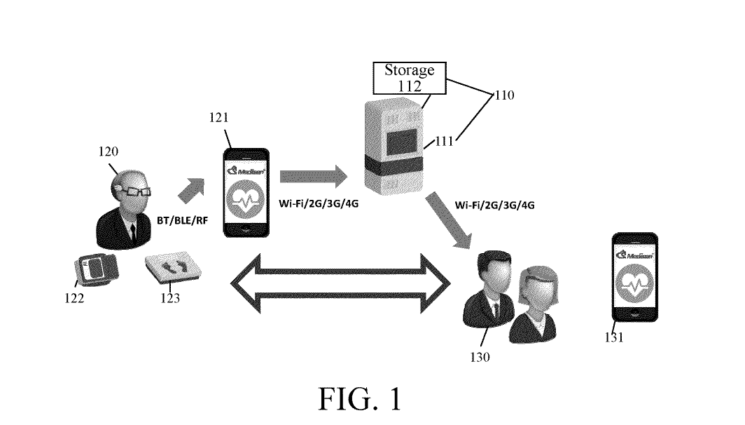

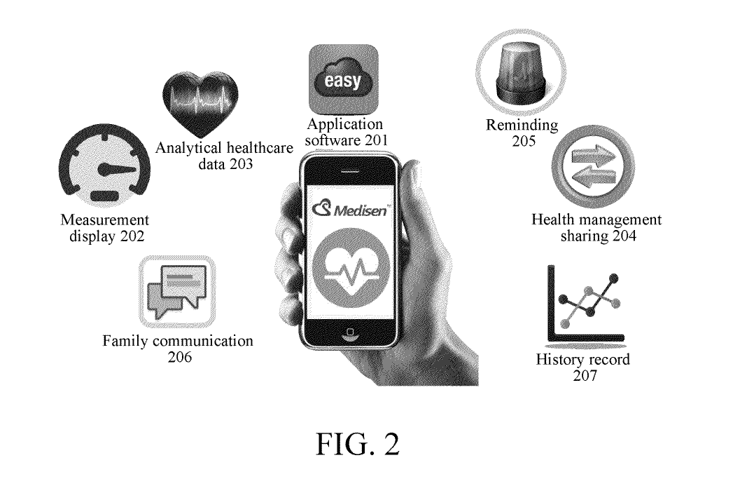

As shown in FIG. 1 and FIG. 2, users of a network-based healthcare monitoring system of an embodiment of this application are mainly classified into two types of users: first users, where most of them are monitored users and usually are the elderly or other people in need, such as patients, and health conditions of such users usually need to be monitored; and second users, where most of them are monitoring users and usually are doctors, caregivers, or relatives or friends of the elderly or the patients, such as children of the elderly, and such users usually need to know the health conditions of the first users. The elderly are mainly used as an example in the following description, but it should be noted that the description is only exemplary description.

Referring to FIG. 1, the network-based healthcare monitoring system of this embodiment of this application mainly includes a system server 110. The system server mainly includes: a data storage device 112, and a central processing device 111 for executing a specific instruction. The data storage device 112 may be, for example, a blade storage array, mainly for storing system-related data such as various measured data about the first user, in the form of a database. The central processing device 111 is used for executing the specific instruction (system software), so as to execute various system-related operations.

The system server 110 supports remote access. The system server 110 can be accessed through a wired or wireless network. For example, the system server 110 can be accessed or provide data outwards through a WIFI/2G/3G/4G mobile network, or the system server 110 can be accessed or send data outwards in a manner such as satellite communication or wireless broadcast communication.

The healthcare monitoring system of this embodiment of this application mainly includes a system side and a user side. The system side is a system server end, and the user side includes a first user and a second user, where the first user, as described above, is usually the monitored user, such as the elderly. The first user can access the system server 110 by using a computing device, such as a personal computer (PC) or a smart device of the first user, and execute various relevant operations. The PC includes, for example, a desktop computer or a notebook computer running a windows operating system or an OS X operating system; and the smart device includes, for example, a smartphone and a tablet computer running an IOS system or an Android system. These computing devices are collectively referred to as a first user apparatus 120. In addition, the first user apparatus further includes a sports or healthcare device or another device of a similar purpose. For example, a sports device 122 may be, for example, a sports wristwatch, which can be taken with the first user and conveniently record sports-related data such as heartbeats, and pulses during sports. A healthcare device 123 includes, for example, a foot massage device, which can carry out a healthcare measure such as massage on the first user and record relevant physiological data of the first user, such as body temperature, blood pressure, heartbeats and pulses. The sports or healthcare device may also include a device of a similar purpose, such as a sphygmomanometer. The sports or healthcare device 122/123 can send the measured physiological data about the first user to a computing device 121, such as a smart device of the first user, in the first user apparatus. The two can communicate between each other in a communication protocol manner such as BT/BLE/RF (Bluetooth/radio frequency). After the sports or healthcare device 122/123 sends the measured data to, for example, a smart device, the smart device can further send it to the system server 110.

As described above, the second user usually refers to the monitoring user. Similarly, the second user can access the system server 110 by using a computing device 131, such as a personal computer (PC) or a smart device of the second user, and execute various relevant operations. The PC includes, for example, a desktop computer or a notebook computer running a windows operating system or an OS X operating system; and the smart device includes, for example, a smartphone and a tablet computer running an IOS system or an Android system. These computing devices are collectively referred to as a second user apparatus 130. The system server 110 may also actively send the measured data to the second user apparatus 130 for the second user to perform processing.

As shown in FIG. 2, the healthcare monitoring system of this embodiment of this application has functions such as a measurement display function, an analytical healthcare data function, an alert and reminding function, a health management sharing function, a family communication function, and a history record function. Analysis of the functions is described below.

Measurement display (on the basis of a measurement display module 202)

By means of this system, the first users, namely the elderly or elder users, can use the sports or healthcare device to do sports or take healthcare. Both of the sports device and the healthcare device have a measurement function for measuring physiological data of the first users, such as body temperature, blood pressure, heartbeats and pulses. The measured data or information can be sent to the smart devices of these users, for example, in a Bluetooth manner. These smart devices are loaded with a software application 201 of this healthcare monitoring system, and the software application 201 has user friendly interfaces and operations. After the smart device of the first user obtains the measured data, this data is sent to the system server through a wireless or mobile device network. Then the system server can send this measured data or information through the wireless or mobile device network to the second user, for example, a family member of the first user. The family member of the first user, namely, a receiver, can send some reply messages and the messages may be in the form of characters or an icon. These reply messages can be returned to a sender, namely, the first user, or be forwarded to another relevant user having the software application.

For the elderly, they can use large screen cell phones for conveniently checking measurement results. When the elderly use the sports or healthcare device, their physiological data is measured and recorded by these devices, and the elderly can review the data by themselves. For the second users, for example, children, caregivers, or doctors of the elderly, they can also obtain the relevant measured data of the first users by means of the system server, so as to monitor health trends of the elderly and even take necessary action before the health conditions of the elderly become worse.

Analytical healthcare data (on the basis of a healthcare data analysis module 203)

After physiological states of the elderly are measured by the sports or healthcare device, the measurement results can be sent to the smart devices by means of Bluetooth or another wireless technology. The software applications of the monitoring systems on the smart devices can analyze the measured data and provide corresponding assessments or corresponding advice, such as excessively high blood pressure, or overweight. The first user or the second user can take further action on the basis of the analysis.

Health management sharing (on the basis of a health management sharing module 204)

As described above, after the physiological data of the first users, such as the elderly, is measured by the sports or healthcare device, the physiological data is sent to the system server by using their smart devices. The system server further sends the measured data to the second users, for example, children, caregivers, or doctors of the elderly, so that the second users can learn of the health conditions of the elderly and implement long distance monitoring on the health conditions of the first users. If the second users find some abnormal situations, they can take action as early as possible, for example, bringing the elderly to see doctors, and adjusting their living styles. Therefore, the system implements the health management sharing for the first users. Not only the first users themselves can monitor their own health conditions, and take necessary action, but also the second users can share the measured data of the first users, so as to take corresponding action.

Alert and reminding (on the basis of an alert and reminding module 205)

An alert threshold is set in the system. Once it is found that the measurement result is out of the threshold, for example, blood pressure exceeds a set threshold, or weight exceeds a set threshold, the system initiates an alert function. Therefore, the first user or the second user can get an alert, so as to take corresponding action. Different methods can be used for reminders, for example, different alarm sounds or different light is used for different reminders to perform prompting with different alert types or alert levels, for example, a red LED lamp is used for alerting in case of excessively high blood pressure, and an orange LED lamp is used for alerting in case of overweight.

A measurement timetable can be further set. The software application of the system reminds the elderly of daily schedules based on the measurement timetable, for example, reminding the elderly to take physiological state measurements. Because reminders are also sent to the second users, even if the elderly miss or neglect the reminders, family members can also be informed and then help to remind the elderly or take further action.

Family communication (on the basis of a family communication module 206)

The measurement results of the elderly can be sent to their family members. By means of this system, communication between system members such as family members of the elderly can further be initiated. For example, the family members can use this system to chat with each other, and the family members of the elderly can express their concern and encouragement to the elderly by using this system.

History record (on the basis of a history record module 207)

The system server can record all measurement results of the first user, and can record measurement data at a specific time by presetting, for example, a time period of recording data. The elderly or the family members can observe changing trends of the physiological data of the first users by means of these history records, which is very useful for knowing the health conditions of the first users. These history records can also be sent to a doctor for reference.

User Friendly APPS

The software application of the healthcare monitoring system of this embodiment of this application uses user friendly design, so that even the elderly can easily use it. A user friendly device may use more icons and less wording, or may use a voice to control an operation, so that the elderly can know functions of the system better and operate the system more conveniently.

The network-based healthcare monitoring system of this embodiment of this application divides a user side into a first user and a second user, where the first users not only can monitor their own physiological states by themselves, but also can assist the second users in monitoring the physiological states of the first users, so as to implement more comprehensive monitoring of the first users, better serve the first users such as the elderly, and enable the first users to receive better care.

What is claimed is:

1. A network-based healthcare monitoring system, comprising:
a system server;
a first user apparatus comprising a first computing device configured to communicate with a sports or healthcare device; the first computing device receiving physiological data of a first user measured and sent by the sports or healthcare device in a wireless communication manner and sending the physiological data to the system server; and
a second user apparatus comprising a second computing device; wherein
the system server comprises a data storage device, and a central processing device configured to execute a specific instruction; the system server supports a wireless or wired access manner and sends the physiological data to the second computing device.

2. The healthcare monitoring system according to claim 1, wherein the data storage device comprises a blade storage array storing system-related data in the form of a database; and the central processing device executes the specific instruction so as to execute various system-related operations.

3. The healthcare monitoring system according to claim 1, wherein the wireless or wired access manner comprises: a WIFI/2G/3G/4G mobile network access manner, or a satellite communication or wireless broadcast communication access manner; and the wireless communication manner comprises a BT/BLE/RF manner.

4. The healthcare monitoring system according to claim 1, wherein the first computing device and the second computing device comprise: a personal computer (PC), or a smart device;
the PC comprises a desktop computer or a notebook computer running a windows operating system or an OS X operating system; and
the smart device comprises a smartphone and a tablet computer running an IOS system or an Android system.

5. The healthcare monitoring system according to claim 1, wherein the system server comprises: a healthcare data analysis module configured to analyze the physiological data and provide a corresponding assessment or corresponding advice.

6. The healthcare monitoring system according to claim 1, wherein the system server comprises: an alert and reminding module configured to set an alert threshold and give out an alert when finding that the physiological data is out of the alert threshold; and
to set a schedule timetable reminder and give out a reminder when a scheduled time is up; wherein
the alert and the reminder use different alarm sounds or light according to different alert and reminder types or levels.

7. The healthcare monitoring system according to claim 1, wherein the system server comprises: a family communication module configured to implement chatting between system members.

8. The healthcare monitoring system according to claim 1, wherein the system server comprises: a history record module configured to record historical measurement data of the first user.

9. The healthcare monitoring system according to claim 1, wherein the system server comprises: user friendly design on which the first computing device and the second computing device are based.

10. The healthcare monitoring system according to claim 9, wherein the user friendly design comprises: an icon display and a voice-operated control.

11. A network-based healthcare monitoring system, comprising:
a system server;
a first user apparatus comprising a first computing device and a sports or healthcare device; the sports or healthcare device measuring physiological data of a first user and sending the physiological data to the first computing device in a wireless communication manner; and the first computing device sending the physiological data to the system server;
a second user apparatus comprising a second computing device; wherein
the system server comprises a data storage device, and a central processing device configured to execute a specific instruction; the system server supports a wireless or wired access manner and sends the physiological data to the second computing device.

12. The healthcare monitoring system according to claim 11, wherein the first computing device and the second computing device comprise: a personal computer (PC), or a smart device;
the PC comprises a desktop computer or a notebook computer running a windows operating system or an OS X operating system;
the smart device comprises a smartphone and a tablet computer running an IOS system or an Android system; and
the sports or healthcare device comprises a sports wristwatch or a foot massage device.

13. A network-based healthcare monitoring method, comprising:
providing a system server;
sending physiological data of a first user, by a first user apparatus, to the system server; and
sending the physiological data, by the system server, to a second computing device; wherein
the system server comprises a data storage device, and a central processing device configured to execute a specific instruction; the system server supports a wireless or wired access manner.

14. The healthcare monitoring method according to claim 13, wherein the data storage device comprises a blade storage array storing system-related data in the form of a database; and the central processing device executes the specific instruction so as to execute various system-related operations.

15. The healthcare monitoring method according to claim 13, wherein the wireless or wired access manner comprises: a WIFI/2G/3G/4G mobile network access manner, or a satellite communication or wireless broadcast communication access manner; and the wireless communication manner comprises a BT/BLE/RF manner.

16. The healthcare monitoring method according to claim 13, wherein the first computing device and the second computing device comprise: a personal computer (PC), or a smart device;
the PC comprises a desktop computer or a notebook computer running a windows operating system or an OS X operating system; and
the smart device comprises a smartphone and a tablet computer running an IOS system or an Android system.

17. The healthcare monitoring method according to claim 13, further comprising: analyzing the physiological data and providing a corresponding assessment or corresponding advice.

18. The healthcare monitoring method according to claim 13, further comprising:
setting an alert threshold and giving out an alert when finding that the physiological data is out of the alert threshold; and
setting a schedule timetable reminder and giving out a reminder when a scheduled time is up; wherein
the alert and the reminder use different alarm sounds or light according to different alert and reminder types or levels.

19. The healthcare monitoring method according to claim 13, further comprising: recording historical measurement data of the first user.

20. The healthcare monitoring method according to claim 13, wherein the system server comprises: a family communication module configured to implement chatting between system members.
